(19) United States
(12) Patent Application Publication
(10) Pub. No.: US 2013/0201904 A1
(43) Pub. Date: Aug. 8, 2013

(54) Handover of Connection of User Equipment

(71) Applicants: Antti Anton Toskala, Espoo (FI); Harri Kalevi Holma, Helsinki (FI); Hannu Pekka Matias Vaitovirta, Espoo (FI); Hannu Tapio Hakkinen, Espoo (FI)

(72) Inventors: Antti Anton Toskala, Espoo (FI); Harri Kalevi Holma, Helsinki (FI); Hannu Pekka Matias Vaitovirta, Espoo (FI); Hannu Tapio Hakkinen, Espoo (FI)

(73) Assignee: Nokia Siemens Networks Oy, Espoo (FI)

(21) Appl. No.: 13/819,365

(22) PCT Filed: Aug. 27, 2010
(86) PCT No.: PCT/EP10/62546

§ 371 Date: Apr. 9, 2013

(51) Int. Cl. H04W 36/16

(52) U.S. Cl. CPC H04W 36/165
USPC 370/315; 370/331

(57) ABSTRACT

There is provided initiating a handover of a connection of user equipment, the connection including a path from an access network to a core network and switching the path to the core network on the basis of data received on the connection exceeding a threshold.

Exemplary and non-limiting embodiments of this invention generally relate to handovers in wireless communications networks.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

The amount of signalling traffic related to handovers may be especially high in networks employing a flat architecture, where handovers may be visible to the cover network. Examples of such networks include Long Term Evolution (LTE) communications networks and networks where Radio Network Controller (RNC) functionalities have been included in base stations.

In LTE the location of User Equipment (UE) may be tracked at an evolved NodeB (eNB) level. A Mobility Management Entity (MME) tracking the location of the UE may control a Serving Gateway (S-GW) to update a General Packet Radio Service Tunnelling Protocol (GTP) tunnel of the UE between the S-GW and Evolved Universal Terrestrial Radio Access Network (E-UTRAN) according to the eNB the UE is connected to.

When the UE makes a handover from a source eNB to a target eNB, a tunnel between the S-GW and the source eNB needs to be released and a new tunnel to the new eNB connecting with the UE needs to be established to enable delivery of data to the UE. Therefore, the handover may involve a lot of signalling traffic between various network nodes. The handover of UE between eNBs also involves the MME generating a new security key to the new eNB. The generation of new keys consumes computational capacity of the MME and increases signalling traffic when the new keys are communicated to the new eNB.

The amount of signalling traffic may further increase when the UE makes handovers frequently, e.g. due to the high speed of the UE or dense deployment of eNBs, for example. Consequently, the amount of signalling traffic capacity needed in network nodes may become very high. It may even be that the signalling traffic introduced by handovers exceeds the capacity of the network nodes to handle signalling traffic. This may lead to unsuccessful handovers that may be perceivable to the UE as connection failures or call drops, for example.

### SUMMARY

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to a more detailed description to be presented later.

Various embodiments comprise one or more methods, one or more apparatuses, one or more computer program products, one or more computer readable mediums, one or more articles of manufacture and one or more systems as defined in the independent claims. Further embodiments are disclosed in the dependent claims.

According to an aspect there is provided initiating a handover of a connection of user equipment, the connection comprising a path from an access network to a core network and switching the path to the core network on the basis of data received on the connection exceeding a threshold

According to another aspect there is provided an apparatus configured to initiate a handover of a connection connecting user equipment, the connection comprising a path from an access network to a core network and switch the path to the core network on the basis of data received on the connection exceeding a threshold.

According to another aspect there is provided an apparatus comprising means for initiating a handover of a connection connecting user equipment, the connection comprising a path from an access network to a core network and means for switching the path to the core network on the basis of data received on the connection exceeding a threshold. According to another aspect there is provided a system comprising an apparatus according to one or more aspects. According to another aspect there is provided a computer program comprising program code means adapted to perform any of steps a method according to an aspect, when the program is run on a computer.

According to another aspect there is provided a computer readable medium comprising computer readable code for executing a computer process according to an aspect.

According to another aspect there is provided a computer program product, comprising a computer usable medium having a computer readable program code embodied therein, said computer readable program code being adapted to be executed to implement a method according to an aspect. According to another aspect there is provided an article of manufacture comprising a computer readable medium and embodying program instructions thereon executable by a computer operably coupled to a memory which, when executed by the computer, carry out the functions according to an aspect.

Some aspects may provide an improvement such that signaling associated with handovers in a communications network may be decreased. Some aspects may provide improved utilization of connections between access nodes of a communications network. Some aspects provide an improvement such that less capacity is needed in network elements to process signalling traffic.

Although the various aspects, embodiments and features are recited independently, it should be appreciated that all combinations of the various aspects, embodiments and features are possible and within the scope of the present invention as claimed.

### BRIEF DESCRIPTION OF THE DRAWINGS

In the following the invention will be described in greater detail by means of preferred embodiments with reference to the accompanying drawings, in which

FIG. 1 illustrates a communications network according to an exemplary embodiment;

FIG. 2 illustrates a process of a source access node in a handover according to an exemplary embodiment;

FIG. 3 illustrates a process of a target access node in a handover according to an exemplary embodiment;

FIGS. 4a and 4b illustrate signalling and data transmission in a handover according to an exemplary embodiment; and

FIG. 5 illustrates an apparatus according to an exemplary embodiment.

### DETAILED DESCRIPTION OF SOME EMBODIMENTS

Exemplary embodiments are now be described more fully with reference to the accompanying drawings in which some, but not all, embodiments are shown. Indeed, the invention may be embodied in many different forms and should not be construed as limited to the embodiments set forth herein; rather, these embodiments are provided so that this disclosure will satisfy applicable legal requirements. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Like reference numerals refer to like elements throughout.

The exemplary embodiments are based on a realization that the amount of data on a connection of UE may be very small and/or no data may need to be transmitted for long periods of time. One example of an application used in UE and generating only a small amount of data on the connection is push email. In push email, only small keep-alive messages may be infrequently transmitted. Accordingly, due to the low use of the connection of the UE, it may be that no data or a relatively small amount of data is transmitted on the connection between handovers of the UE.

The present invention is applicable to any access node, eNB, relay node, server, corresponding component, and/or to any communications system or any combination of different communications systems that connect UE to a core network via an access network. The communications system may be a fixed communications system or a wireless communications system or a communications system utilizing both fixed networks and wireless networks. The protocols used, the specifications of communications systems, servers and user terminals, UE, especially in wireless communications, develop rapidly. Such development may require extra changes to an embodiment. Therefore, all words and expressions should be interpreted broadly and they are in-tended to illustrate, not to restrict, the embodiment.

Examples of communications systems, to which the exemplary embodiments may be applied may include communications standards or technologies including but not limited to: TETRA (Terrestrial Trunked Radio), LTE (Long Term Evolution), GSM (Global System for Mobile Communications), WCDMA (Wideband Code Division Multiple Access), WLAN (Wireless Local Area Net-work), WiMAX (Worldwide Interoperability for Microwave Access) or Blue-tooth® standard, or any other suitable standard/non-standard wireless communication means. Wired connections in a communication system 100 may be implemented for example using an Asynchronous Transfer mode (ATM), Ethernet, E1 or T1 lines.

The following exemplary embodiments may be applied to any kind of handovers, including hard handovers, where the UE is connected to only one access node at a time, soft handovers, where UE maintains at least one connection to an access node during the handover, and softer handovers, where a handover occurs between sectors or cells within one access node and the UE maintains at least two connections to the access node during the softer handover. The handovers according to the exemplary embodiments may be controlled by an access node, a network controller, or the UE. In the exemplary embodiments, the handovers are described as controlled by access nodes.

In the following exemplary embodiments, relaying comprises receiving messages on a first connection and transmitting at least a part of the received messages on another connection. Accordingly, the relaying may comprise decoding the received messages to derive contents from the received message and forming a new message to be transmitted and comprising the derived contents.

In the following exemplary embodiments, a source access node may refer to an access node that provides access to the UE when a handover is started. A target access node may refer to an access node that provides access to the UE when the handover is completed. Accordingly, during the handover, the connection of the UE to the source access node may be released and a connection may be established to the target access node.

A network architecture and elements that may be employed in the exemplary embodiments described herein may be referred in 3GPP Long Term Evolution (LTE) and 3GPP TS 36.401 V9.2.0 (June 2010) Technical Specification 3rd Generation Partnership Project; Technical Specification Group Radio Access Network; Evolved Universal Terrestrial Radio Access Network (E-UTRAN); Architecture description (Release 9), which is incorporated herein by reference.

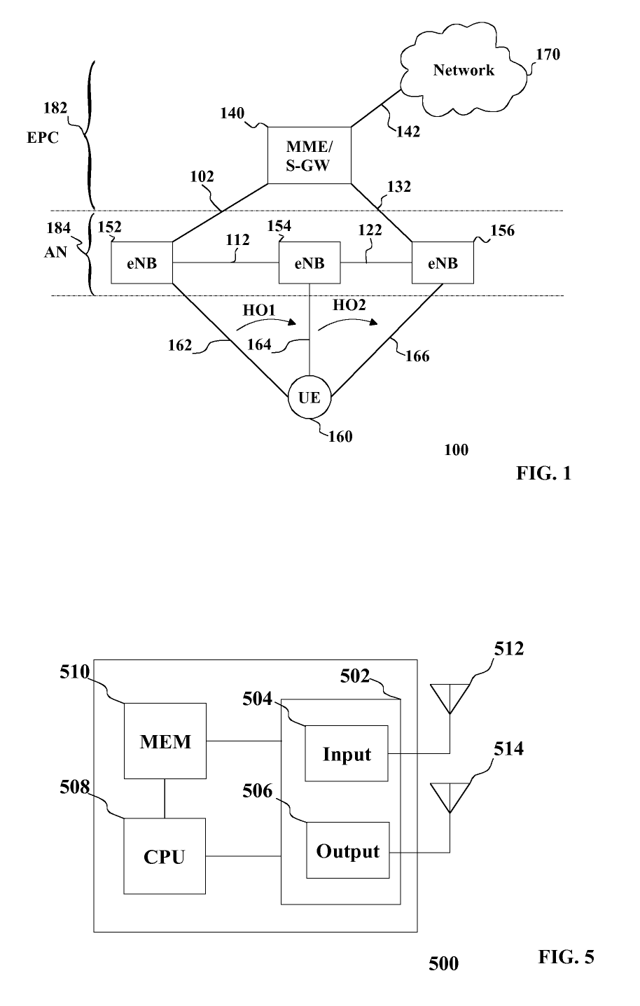

A general architecture of a communications network 100 according to an exemplary embodiment is illustrated in FIG. 1. FIG. 1 is a view of a simplified system architecture, only showing some elements and functional entities, all being logical units whose implementation may differ from what is shown. The connections shown in FIG. 1 are logical connections; the actual physical connections may be different. It is apparent to a person skilled in the art that the systems also comprise other functions and structures.

The exemplary communications network 100 may comprise a core network 182 that may provide various services to UE 160 connected to an access network 184. The services may comprise, but are not limited to, mobility management, UE location tracking and controlling, establishing and releasing resources to UE.

The access network may comprise one ore more access nodes 152, 154, and 156 that may provide one or more UE 160 with access to the communications network. When the UE accesses the communications network via an access node, a connection may be established between the access node and the UE to connect the UE to the communications network. The connection may comprise signalling and/or user data, or a connection may be established for the signalling data and another connection may be established for the user data.

The access provided by an access node may comprise wireless access, e.g. a wireless radio access, where the UE may communicate with an access node by employing one or more radio frequencies using resources allocated to the UE. The resources may comprise one or more frequencies, time slots, codes or any combination thereof. The resources may be allocated to the UE for example by the access node.

The communications between the UE and an access node may comprise uplink and/or downlink communications. In uplink communications, the UE may transmit one or more messages to the access node. In downlink communications, an access node may transmit one or more messages to the UE.

An access node may provide a wireless radio access in one ore more cells that may operate on different radio frequencies, codes or have spatial separation, or a combination of one or more thereof. A service area of an access node may comprise a coverage area of the access node.

Within the coverage area of the access node, the UE may transmit and/or receive messages to/from the access node. In an embodiment, the access network may comprise the Universal Terrestrial Radio Access Network (UTRAN) or Evolved UTRAN (E-UTRAN), for example.

In an embodiment, an access node may comprise an infrastructure node, a base station, an access point, a NodeB, an enhanced NodeB (eNB), or a relay node, for example.

In an embodiment, the access node provides a radio access by employing High Speed Packet Access (HSPA) radio technology and comprises an integrated Radio Network Controller (RNC). Thus, the network architecture may be provided without separate RNCs, while the amount of signalling traffic related to handovers may be kept low.

The core network may comprise one or more core network nodes that may connect to one or more access nodes of the access network, as illustrated by a core network node 140 connecting to the access node 152 on a connection 102 and to the access node 156 on a connection 132. Each connection between the access nodes and the core network may provide a path for data of the UE accessing the communications network. One or more resources may be reserved on a connection between an access node and a core network node for data of the UE. The resources may comprise.

In an embodiment, the core network comprises an Evolved Packet Core (EPC), for example.

In an embodiment, one or more core network nodes, e.g. the node 140, comprise one or more from group comprising a

Serving Gateway (S-GW), a System Architecture Evolution Gateway (SAE-GW), a Mobility Management Entity (MME), for example. One or more nodes of the core network may be combined in a single functional entity. Accordingly, the core network node 140 may provide both an MME and an S-GW functionality.

The access nodes of the access network may be interconnected. In the example of FIG. 1, the access node 152 may be connected to the access node 154 on a connection 112 and the access node 154 may be connected to the access node 156 on a connection 122. In an embodiment, a connection between access nodes may be a tunnel between access nodes of an access network, where each of the access nodes operates as an endpoint of the tunnel. The tunnel may be used for transmitting user and/or signalling data. A tunnel Endpoint Identifier (TEID) may be used for identifying an endpoint in the tunnel. The tunnel may be a GTP tunnel, for example.

Some access nodes may be connected to the core network through other access nodes. The access node 154 may be connected to the core network by connecting to the access node 152 that provides the connection 112 to the core network. Furthermore, the access node 154 may be connected to the core network by connecting to the access node 156 that provides the connection 132 to the core network. Accordingly, the access nodes according to the exemplary embodiments may have one or more connections to the core network. In an embodiment, a connection between two access nodes may be provided by relaying. Accordingly, an access node may not have a direct connection to another access node. For example, the access node 152 may not have a direct connection to the access node 156. Then the connection between the access nodes 152 and 156 may be provided by the access node 154 relaying data and/or messages between the access nodes 152 and 156. It should be appreciated that instead of the access node 154, there may be a plurality of access nodes that provide the relaying between the access nodes 152 and 156.

In an embodiment, a connection of the UE may comprise an access network path and a core network path for carrying data to and/or from the UE.

In an embodiment, data of the UE may comprise user and/or signalling data. The access network path provides delivery of the data between an access node connecting to the UE and an access node connecting to the core network and/or other access nodes. The access node connecting to the UE and the access node connecting to the core network may be the same or different access nodes. The core network path provides delivery of the data between the access network and the core network. The core network path may comprise an access node of the access network that provides a connection to the core network and one or more core network nodes.

In an embodiment, a core network path comprises a tunnel between an access node of an access network and a core network node, where the access node and core network node operate as endpoints of the tunnel. The tunnel may be used for transmitting user and/or signalling data between the core network and the access node providing access to the UE. A Tunnel Endpoint Identifier (TEID) may be used for identifying an endpoint in the tunnel. The tunnel may be a general packet radio service Tunnelling Protocol (GTP) tunnel, for example.

The core network may be connected to other networks 170 on a connection 142. The other networks may comprise GSM, UMTS, CDMA2000, and WiMAX, the Internet or other core networks, for example.

In exemplary embodiments where the UE connects to a communications network through an access node of the access network, a core network path may be provided by the same access node. Accordingly, the access node may relay the data of the UE directly, with no further intermediary access nodes, between the core network path and the UE.

In an exemplary embodiment, in a handover of the UE, an access network connection of the UE may be switched from one access node to another in handovers HO1, HO2. Accordingly, the UE may first connect to the eNB 152 that also provides a core network path to the UE. When the UE is handed over to another access node, the core network path may still be provided by the eNB 152 by relaying data of the UE between the access nodes in the access network.

In the handover HO1, the access network connection of the UE to the access node 152, a source access node, may be switched to the access node 154, a target access node. A previous connection of the UE to the access node 152 may be released when the UE has established a connection with the target access node. The core network path of the connection of the UE may be maintained at the access node 152 and the access network connection may be provided by the access node 154. Data of the UE may be relayed between the access nodes 154 and 152. Thereby, the data of the UE may be delivered to/from the core network path and the core network path of the UE may be maintained at the access node 152.

In the handover HO2, the access network connection of the UE may be switched from the access node 154 to the access node 156. Data of the UE may be relayed between the access nodes 156 and 154 and between the access nodes 154 and 152. Thereby, the data of the UE may be delivered to/from the core network path and the core network path of the UE may be maintained at the access node 152. Accordingly, when the UE connects to a communications network through an access node that is different from the access node providing the core network path, data of the UE may be relayed in the access network between the access node providing the access and the access node providing the core network path. The relaying may comprise relaying the data on the connections between the access nodes.

In exemplary embodiments, the connections illustrated in FIG. 1 may comprise both user and signalling data of the UE. The user data may comprise user plane data, for example media traffic to/from the UE, e.g. speech, voice, video, audio, messages, email, FTP or HTTP traffic. The signalling data may comprise control plane data for example one or more signalling messages for establishing, supervising and releasing one or more connections of the UE. In an exemplary embodiment, the communications network in FIG. 1 comprises an LTE network, where the access network may be an E-UTRAN and the core network may be an EPC. In the E-UTRAN, the access nodes may be referred to as eNBs. The connections between the eNBs in FIG. 1 may be implemented as X2 interfaces according to E-UTRAN specifications defined by 3GPP. X2 is an interface for the interconnection of two E-UTRAN NodeB (eNB) components within the Evolved Universal Terrestrial Radio Access Network (E-UTRAN) architecture. GTP tunnelling may be used on the connections to tunnel data between eNBs.

In the LTE, the connection between the E-UTRAN and the EPC may be implemented as S1 interface that may be implemented in an eNB of the E-UTRAN and in core network nodes connecting with the eNB. An eNB connected to an MME may comprise an S1-MME interface for a control plane data and an access node connected to an S-GW may comprise an S1-U interface for a user plane data. When the S-GW and MME reside in a single node, the eNB may comprise both S1-MME and S1-U interfaces. The connection between the access and the core network node may use a GTP for tunnelling of data.

In an LTE communications network, the UE may operate in an RRC_IDLE state or an RRC_CONNECTED state. In the RRC_CONNECTED state, the UE may have a connection to the eNB that provides delivery of control plane data between the UE and the eNB. During the RRC_CONNECTED state, the

MME serving the UE may perform mobility management, e.g. track a location of the UE. The location of the UE may be tracked e.g. at a tracking area, eNB level or at a cell level, or as any combination thereof. A tracking area comprises a set of eNBs, where the UE may be reached by paging.

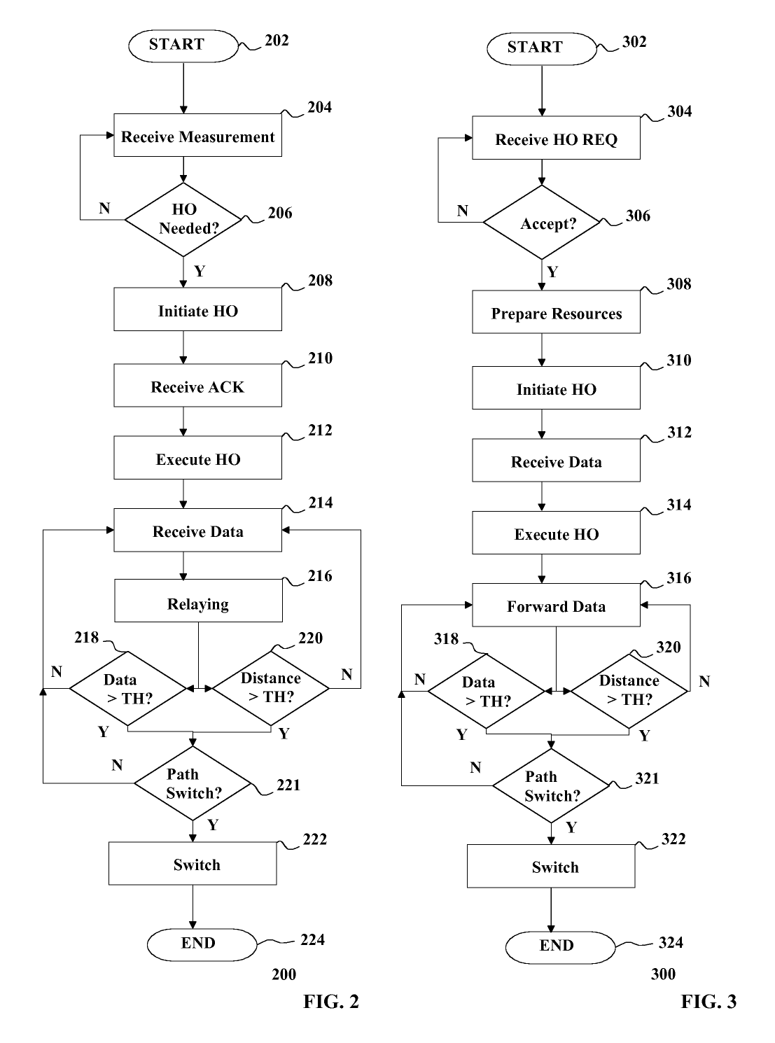

FIG. 2 illustrates a process 200 performed by a source access node when UE having a connection to a communications network and comprising a core network path performs a handover, according to an exemplary embodiment. Accordingly, data of the UE may be transmitted between the UE and the core network. In the following, the process is described in the context of the LTE and the E-UTRAN. The process may be performed in the exemplary communications network of FIG. 1 for example by an eNB. The process starts in 202, where the UE performs measurements when connected to the eNB.

In 202, a measurement report may be received from the UE on a connection between the eNB and the UE. The connection may comprise an air interface connection, e.g. a radio interface LTE-Uu. The measurement report may comprise measurement information, e.g. a Reference Signal Received Power (RSRP), a Reference Signal Received Quality (RSRQ) and/or a Received Signal Strength Indicator (RSSI) of a neighbouring eNB. The measurement information may further comprise information identifying the measured neighbouring eNB, e.g. a Physical Cell Identifier of a cell of the neighbouring eNB.

In 206, a decision to handover the UE is made on the basis of the received measurement report. The measurement report may be compared with one or more criteria for initiating a handover, e.g. the measurement information meeting a threshold. If the criteria to perform a handover are met, the handover may be initiated in 208. Otherwise, the connection of the UE may be maintained at the current eNB and the process proceeds to 204 to receive further measurement reports from the UE.

After the source eNB has decided in 206 to handover the UE to a target eNB, the source eNB may initiate the handover in 208 by transmitting a handover request to the target eNB. If the source eNB does not have a connection to the target eNB, the initiating may comprise establishing a connection to the target eNB for transmitting the request. The connection may be a direct connection, e.g. an X2 connection. The target eNB may be the measured eNB in the received measurement report in 202.

In an embodiment, the initiating in 208 of the handover comprises transmitting to the target eNB a counter indicating a distance between the UE and the eNB providing the core network path. The counter may indicate distance information, a measure of distance, a number of omitted path switches, a number of relayed X2 connections, a number of eNBs between the UE and the core network and/or a number of core network path switches that have been omitted. The counter may comprise an Information Element (IE) comprising data indicating a value of the counter. The data may comprise one or more bits or bytes. The counter may be included e.g. in a handover request transmitted to the target eNB or the counter may be transmitted in a separate message to the target eNB.

In one example, the counter may be updated when the source eNB maintains the core network path of the UE. When the core network path is being maintained, the source eNB performs no path switch of the core network path of the UE. The counter may be updated e.g. by incrementing the counter. For example, the counter may be set to an initial value of ‘1’, when the UE is connected to the eNB providing the core network path. The counter may be updated e.g. by incrementing it to a value of ‘2’, when the core network path of the UE is maintained, thus no switch of the core network path is performed by the source eNB. The target eNB may then determine from the value ‘2’ of the counter that when the UE connects to the target eNB, the UE is connected to the core network via two eNBs. Since more than one eNB exists between the UE and the core network, the target eNB may determine that the source eNB has omitted a core network path switch. Accordingly, the counter may be effectively used as an omitted path switch counter.

In an embodiment, in 208, the counter may be transmitted to the target eNB after the counter has been updated. When the counter is updated a plurality of times at the source eNB, the counter may be transmitted to the target eNB after every update to ensure that the target eNB is informed about the distance between the UE and the eNB providing the core network path.

In an embodiment, in 208, the initiating may comprise generating one or more new security keys to be used for securing the connection between the target eNB and the UE, i.e. in an access stratum. The new security key may be derived from the security key used for securing the connection between the source eNB and the UE at the source eNB. Thus, the new key may be derived horizontally without any involvement of the MME. The generated security key may be included e.g. in a handover request transmitted to the target eNB or the generated security may be transmitted to the target eNB in a separate message.

Examples of security key derivation may be found in E-UTRAN 3GPP TS 33.401 V8.7.0 (April 2010) Technical Specification 3rd Generation Partnership Project; Technical Specification Group Services and System Aspects; 3GPP System Architecture Evolution (SAE): Security architecture (Release 8). In an embodiment according to the above-mentioned specification, a new security key K_{eNB}_{_{—}}_{target} for the target eNB may be derived from the currently active security key K_{eNB}_{_{—}}_{source} at the source eNB, a Physical Cell Identifier (PCI) identifying a cell of the target eNB and an E-UTRA Absolute Radio Frequency Channel Number-Down Link (EARFCN-DL) of the target cell. This may be referred to as horizontal key derivation. An example of a key derivation function that may be used for deriving the security key may be found in Annex 5 of the 3GPP TS 33.401 referred to above.

When horizontal security key derivation as described above is performed, the security key for the target eNB may be obtained without any involvement of the MME in the key derivation. Accordingly, no signaling is required to request the MME calculate the security key, e.g. a path switch request, and computational resources of the MME may also be saved.

In 210, a response to the handover request may be received from the target eNB. The response may indicate that the target eNB is ready to receive the incoming UE. Accordingly, the target eNB may have prepared resources for the incoming UE. The response may be a handover acknowledgement, for example.

In 212, the handover execution may be started. The execution may comprise transmitting to the UE a handover command to switch the UE to the target eNB. When the UE receives the handover command it may disconnect from the source eNB and start to synchronize with the target eNB. In an embodiment, in 212, the execution of the handover may comprise transmitting to the target eNB the counter described in connection with step 208 and indicating a distance between the UE and the eNB providing the core network path. Accordingly, in this embodiment, the source eNB may have updated the counter after the initiation of the handover and a path switch after the initiation of the handover may be indicated to the target eNB. Thus, the source eNB is allowed more time to perform a path switch and update the counter than if the counter was transmitted to the target eNB in the initiation of the handover 208. After the execution is started the UE is no longer transmitted any data. When the UE has established a new connection to the access network at the target access node, the UE may start transmitting data to be delivered towards the core network. In 214 data of the UE may be received. The data may be received from the core network path of the UE and/or from the target eNB over the connection between the eNBs. The data may comprise user data and/or signalling. Accordingly, the core network path of the UE may be maintained at the source eNB.

When the core network path is maintained, data of the UE may be delivered between the core network path and the UE by the source and target eNBs relaying 216 the data of the UE through the access network. Accordingly, the connection between the source and target access nodes may be utilized to deliver the data of the UE through the access network, and the received data may be transmitted towards its destination on the connection to the target eNB or on the core network path to the EPC, e.g. the S-GW in the EPC. It should be appreciated that in 216 the data of the UE may be relayed in the access network between the source and target eNBs via one or more other eNBs that provide relaying of data and/or messages between the source and target eNBs. In an embodiment, the data of the UE comprises user data and/or signalling data. The user data may comprise user plane data. The signalling data may comprise one or more messages transmitted between network nodes involved in a control plane procedure associated with the connection of the UE. The messages may thus comprise control plane messages. The network nodes associated with the control plane procedure may comprise e.g. UE, eNB or MME. Examples of the control plane procedures include bearer management, such as establishment and release of bearers, paging, and SMS delivery. Examples of a bearer comprise a Signalling Bearer (SB) carrying signalling messages, and a user plane Radio Bearer (RB) carrying user data. In this way the signalling and/or user data associated with the connection of the UE may cause the threshold to be exceeded, and the process may proceed to 221 and make a decision about the path switch.

In one example, the signalling data may comprise one or more control plane messages between the core network and the eNB providing the core network path. The control plane messages may comprise Application Protocol (AP) messages received on an S1 or an X2 interface, i.e. S1AP or X2AP messages. Examples of the S1AP messages include e.g. a Radio Access Bearer (RAB) Release, RAB Modify, and a Paging message. In another example, the signalling data may comprise one or more control plane messages between the UE and the core network, e.g. the MME serving the UE. Examples of the messages include Non-Access Stratum (NAS) messages, e.g. a Short Message Service (SMS) message.

In an embodiment, in 216, one or more tunnels, e.g. GTP tunnels may be established between the source eNB and target eNB to relay the user data of the UE between the eNBs. In an embodiment, in 216, the signalling received in 214 may be relayed between the source and target eNBs on a control plane connection between the eNBs. For example, S1AP messages may be relayed on X2AP extensions over the X2 interface between the eNBs.

In 218, it may be determined if the data received in 214 exceeds a threshold set for the data, TH_{data,source}. The received data may be measured by amount thereof, e.g. by the volume, the number of messages, the number of packets, or throughput, for example. The volume may be measured e.g. by the total amount of received data in bytes. The number of packets may be the total number of packets or a number of packets meeting one or more criteria, e.g. the size or a type of packet. The throughput may be measured by the volume of data in a period of time. Accordingly, the threshold TH_{data,source} may be set according to a volume of data, the number of packets, or throughput, or any combination thereof. When the threshold TH_{data, source} is exceeded, the process proceeds to 221. When the threshold is not exceeded, the process proceeds to 214 to receive further data.

In an embodiment in 218 the threshold TH_{data,source} for the amount of data may be set as the number of messages received. The TH_{data,source} may be set as the number of messages of a specific protocol, and/or associated with a control plane or a user plane, for example. Accordingly, the threshold may be set as one control plane message associated with the connection of the UE, e.g. an S1AP message or an NAS message, or as one user plane data packet. In one example, a user plane data packet may be related to keep-alive signalling.

In one example, the TH_{data,source} the may be set as a single user plane or control plane data packet received on the connection of the UE. Accordingly, the first packet transmitted to/from the UE may cause the threshold to be met and a resulting core network path switch.

In 220 it may be determined if a distance between the UE and the core network path exceeds a threshold set for the distance, TH_{dist,source}. The distance may comprise one or more from a group comprising: an omitted path switch counter, a number of access nodes, a difference between tracking area identifiers of source and target access nodes, addresses of source and target access nodes, measurement information on a target access node, a timer or any combination thereof. The omitted path switch counter was explained above in steps 208 and 212. If the distance is below the threshold TH_{dist,source}, the process may proceed to 214 to receive more data on the connection of the UE. When the distance exceeds the threshold TH_{dist,source}, the process may proceed to 221.

In 221 it may be determined if a core network path of the UE should be switched. The decision about the path switch may be made on the basis of the condition of step 218 or the condition of step 220 being met or both the data in step 218 and the distance in step 220 exceeding their thresholds.

In 222 the core network path of the UE may be switched. This may comprise releasing resources allocated to the UE. The resources may comprise, resources on the connection between the eNBs, for example one or more tunnels for carrying data of the UE. The resources may further comprise resources of the core network path. The core network path resources may comprise one or more tunnels for carrying data of the UE. The resources may be released in response to a request from the target eNB, a Release Request, on the X2 connection. In response to the Resource Release request on the X2 connection a request to release resources may be transmitted on the core network path so as to request release of the core network path of the UE. The request on the core network path may be destined to the MME, for example. After releasing the resources allocated to the UE, the handover of the UE from the source eNB to the target eNB is complete and the process ends in 224.

In an embodiment in 222, when the data received in 214 includes one or more signalling messages, the source eNB may transmit the signalling messages to the target eNB over the X2 interface between the eNBs, as explained in 216. The signalling messages may be associated with a control plane procedure, e.g. paging of the UE, or bearer management of the UE such as establishment or release of bearers. The signalling messages transmitted to the target eNB may trigger the target eNB to perform the core network path switch of the UE. In this way, the target eNB may continue the procedure associated with the signalling messages directly with the MME. For example, a bearer release message from the MME may be relayed to the target eNB from the source eNB via the X2 interface between the eNBs.

Then, the target eNB may transmit a response to the bearer release message directly to the MME. Since the bearer release message is forwarded from the source eNB to the target eNB, the MME doesn't have to retransmit the bearer release message to the target eNB, but the MME may continue the bearer release procedure with the target eNB.

In an embodiment in 222, instead of transmitting the received signalling messages to the target eNB as above, the source eNB may transmit to the target eNB a triggering message to cause the target eNB to perform a core network path switch. The triggering message may comprise a signalling message. The triggering message may be transmitted on the X2 interface between the eNBs and comprise an X2 Application Protocol (AP) message or one or more information elements of an X2AP message.

In an embodiment in 222, the received signalling messages comprise an MME originated signalling message and, in response to the message, the source eNB transmits a message indicating a failure of the procedure associated with the signalling message. One example of the response message indicates the cause of the failure, e.g. triggered X2 handover. The response message may comprise e.g. an S1AP message to the MME. In this way the MME may indicate that the UE is not connected to the source eNB and may not be reached. When the response message indicates that the cause is a triggered X2 handover, the MME may expect a core network path switch of the connection of the UE. When the target eNB performs a core network path switch of the UE, the MME may retry the procedure associated with the signalling message, e.g. re-transmit the signalling message to the target eNB whereto the UE was handed over.

Since the amount of data and/or distance may be used for determining when to switch the core network path, the signalling traffic in the communications network associated with handovers may be reduced. Thus, less capacity is needed in network elements to process signalling traffic. Since the path switch may be initiated when the data on the connection exceeds a threshold, the efficiency of signalling associated with path switching may be improved.

Accordingly, the proportion of UE data to the signalling traffic may be increased. The threshold for the distance between the core network path and the UE may be used for switching the core network path so as to keep the delays caused to the data delivered via X2 connections between the eNBs at an acceptable level. When both the distance and the data are used for determining when the core network paths should be switched, both the signalling associated with paths switches and the delays caused to the relayed data may be optimized.

FIG. 3 illustrates a process 300 performed by a target access node in a handover receiving an incoming UE having a connection to a communications network and comprising a core network path, according to an exemplary embodiment. In the following the process is described in the context of the LTE and the E-UTRAN. The process may be performed for example by an eNB of the exemplary communications network of FIG. 1. The process starts in 302, where an X2 connection has been established between source and target eNBs.

In 304 a handover request may be received. The handover request may initiate a handover of the UE to the target eNB.

In an embodiment the handover request comprises a counter indicating a distance between the UE and the eNB providing the core network path. The counter is described in steps 208 and 212 of FIG. 2, for example. From a value of the counter, the target eNB may determine that the source eNB has omitted a core network path switch. Accordingly, the counter may be effectively used as an omitted path switch counter.

In an embodiment, the handover request may comprise one or more security keys, as described with step 208 of FIG. 2, for securing the connection between the UE and the target eNB.

In 306 the target eNB determines whether the handover of the UE may be accepted. A decision as to whether to accept the handover may be made on the basis of interference and/or available resources, for example. If the handover is not accepted, the process proceeds to 304 to receive further handover requests.

When the handover of the UE is accepted, the process proceeds to 308, where the target eNB prepares resources for the incoming UE.

In 310 the target eNB initiates the handover by transmitting an acknowledgement to the source eNB. The acknowledgement may comprise a Handover Request Acknowledgement. The acknowledgement indicates to the source eNB that the handover may be performed.

In 312 data of the UE may be received. The data may be received from the source eNB that relays data from the core network path of the UE over the connection between the eNBs.

In 314 the target eNB may execute the handover. The execution may comprise allocating resources to the UE at the eNB. Information of the allocated resources may be transmitted to the UE in a message, e.g. an Uplink (UL) Allocation message. The UL Allocation message may also comprise information about a timing advance to be used by the UE in transmissions to the eNB. In 314 the execution of the handover may be started in response to the UE initiating a procedure to access the eNB and the eNB receives an access message from the UE. The access procedure may be a RACH procedure and the access message may be a RACH message, for example.

In 316 data may be relayed between the UE and the source eNB after the UE has connected to the target eNB. Accordingly, when the UE is connected to the target eNB, the access network connection of the UE has been switched to the target eNB from the source eNB and data of the UE may be received from the core network path over the connection between the source and target eNBs and/or from the UE over the air interface.

It should be appreciated that similarly to explained in connection with step 216 of FIG. 2, the connection between the source and target eNBs may be provided by one or more eNBs relaying data and/or messages between them. In an embodiment, in 316 the security keys received in step 304 may be used for securing the connection between the UE and the target eNB. Accordingly, data received and transmitted on the connection may be ciphered using the received security keys.

In 318 it may be determined if the received data of the UE exceeds a threshold set for the data, TH_{data,target}. This may be performed in a manner similar to that described in connection with step 218 at the source eNB. The threshold for data may be different at the target eNB from that in the source eNB, or they may be the same. When the threshold is exceeded the process may proceed to 321. When the threshold is not exceeded, the process may proceed to 316 to continue relaying.

In 320 it may be determined if the distance between the UE and the core network path exceeds a threshold set for the distance, TH_{dist,target}. This may be performed in a manner similar to that described in step 220 at the source eNB. The threshold for the distance may be different at the target eNB from that in the source eNB, or they may be the same. When the threshold is exceeded the process may proceed to 321. When the threshold is not exceeded, the process may proceed to 316 to continue relaying.

In 321 it may be determined if a core network path of the UE should be switched. A decision about a path switch may be made on the basis of meeting the condition of step 318 or and the condition of step 320 being met or both the data in step 318 and distance in step 320 exceeding their thresholds.

In 322 the core network path of the UE may be switched. This may comprise requesting a core network path switch from the MME serving the UE. The MME controls the S-GW to switch the GTP tunnel from the source eNB to the target eNB. After the GTP tunnel has been switched, a response to the request may be received from the MME that indicates that the path switch has been performed. A release request may then be transmitted to the source eNB to release resources associated with the UE. After the core network path switch has been performed, UE data may be delivered directly between the core network path and the new eNB providing access to the UE with no intermediary eNBs. Accordingly, UE data may be received at the new eNB directly from the S-GW on the GTP tunnel. Also data originating from the UE may be transmitted directly from the new eNB to the S-GW. The handover is complete and the process ends in 324.

Since the core network path is switched only after the criteria concerning data volume and/or distance are met, the signalling traffic in the communications network associated with handovers may be reduced. Thus, less capacity is needed in network elements to process signalling traffic. Since a path switch may be initiated only when the data on the connection exceeds a threshold, the efficiency of signalling associated with path switching may be improved. Accordingly, the proportion of UE data to the signalling traffic may be increased. The threshold for the distance between the core network path and the UE may be used for switching the core network path so as to keep the delays caused to the delivered data at an acceptable level.

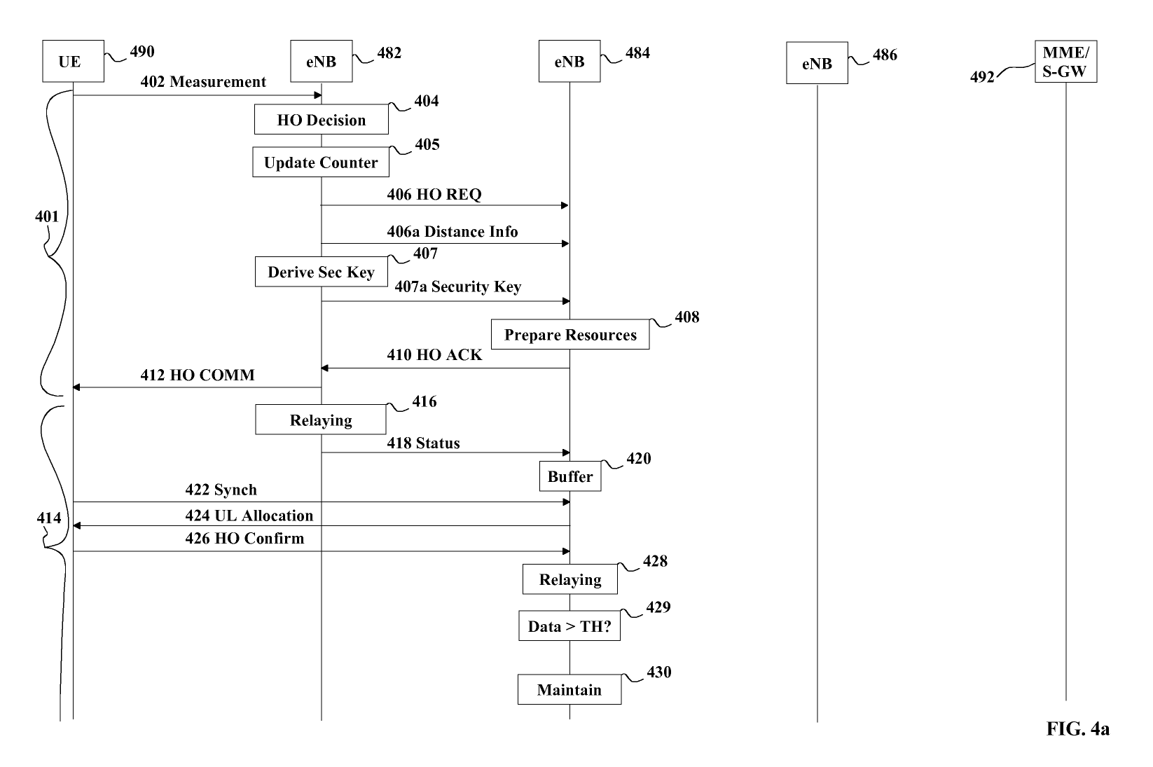

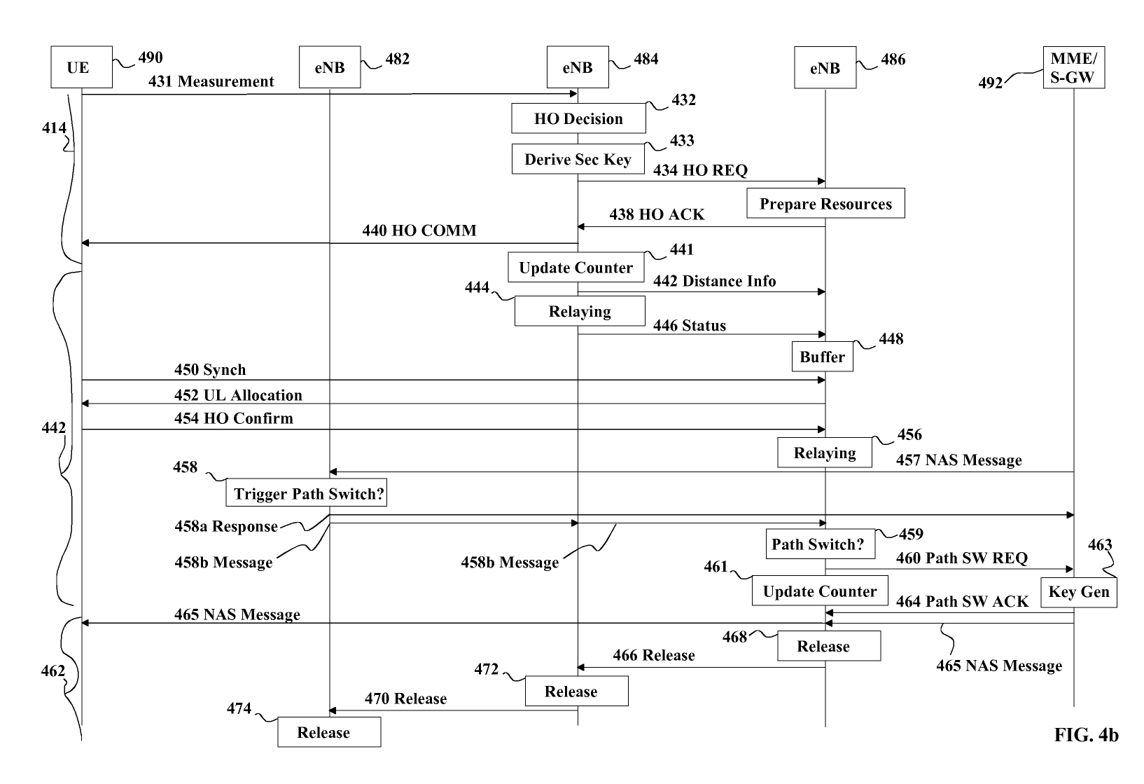

FIG. 4a and FIG. 4b illustrate signalling and UE data routing associated with a handover according to an embodiment. The embodiment may be performed in the communications network of FIG. 1. One or more steps of the processes described in FIGS. 2 and 3 may be used in one or more eNBs in FIG. 4a and FIG. 4b. In the following, reference is made to the steps of FIGS. 2 and 3 together with the items in FIGS. 4a and 4b. The signalling illustrated in FIG. 4a continues in FIG. 4b. FIGS. 4a and 4b include eNBs 482, 484 and 486 that may provide access to the UE 490. It should be appreciated that each of the eNBs may have a connection to the other eNBs and/or a connection between the eNBs may be provided by relaying messages between the eNBs.

Four phases 401, 414, 442 and 462 are illustrated in FIGS. 4a and 4b. In the first phase the core network path of the UE may be provided by the eNB that connects to the UE. The first phase is now described.

In FIG. 4a UE 490 is first connected to an eNB 482. The UE performs one ore more measurements and transmits a measurement report 402 that may be received by the eNB 482. The eNB makes a handover decision in 404. This may be performed as described in 206, for example.

In an embodiment a counter for omitted path switches may be updated in 405 at the eNB 482 after a decision to handover the UE was made. Since the handover decision has been made in 404, the eNB 482 may defer performing a core net work path switch of the UE and the counter may be updated as explained in 208.

The eNB 482 decides to handover the UE to a new eNB 484 and initiates 208 the handover to the eNB 484, thus the eNB 482 may now be referred to as a source eNB and the eNB 484 as a target eNB. A handover request 406 may then be transmitted to the target eNB by the source eNB.

In an embodiment the handover request comprises the path switch counter updated in 405.

In an embodiment, the path switch counter updated in 404 is transmitted in 406a as a separate message to the target eNB 484. The separate message may comprise an X2AP message comprising Distance Information IE, for example.

In an embodiment, a security key for the target eNB may be generated in 407 horizontally, as described in 208. Accordingly, the security key to be used between the target eNB and the UE may be derived from the security key used between the source eNB and the UE. The derived security keys may be transmitted to the target eNB in 407a in a separate message.

The target eNB prepares 308 resources in 408. The target eNB initiates 310 the handover by transmitting a handover request acknowledgement 410.

When the source eNB receives the handover request acknowledgement 410 from the target eNB, the execution of the handover may be started 212 by transmitting a handover command 412 to the UE. After the execution has been started, no UE data may be delivered from the source eNB directly to the UE. The first phase ends.

In the second phase 414, the core network path of the UE may be provided by relaying 416 data between the UE and the access node providing the path from the access network to the core network, as described in 216. Accordingly, UE data may be relayed to and/or from the core network path provided by the source eNB. In 418 the source eNB transmits to the target eNB status information indicating the packets that were acknowledged by the UE. The target eNB starts buffering the data relayed form the source eNB in 420.

The UE synchronizes with the target eNB and accesses the cell via a RACH procedure in 422. The execution of the handover may be started as described in 314.

In 424 the target eNB gives uplink allocation and timing advance information to the UE.

When the target eNB receives a handover confirm message 426 from the UE, data may be transmitted to the UE. The UE now has a connection to the eNB.

In 428 UE data may be relayed between the UE and the core network path through the source and target eNBs, as described in 316.

In 429 it may be determined whether the data received at the target eNB on the connection of the UE exceeds a threshold as described in 318. In addition to the threshold for the amount of data it may also be determined whether the distance to the core network path exceeds a threshold as described in 320.

In 430 none of the thresholds are exceeded: thus, the target eNB determines to maintain the path to the core network on the basis of the data received on the network connection is below a threshold and/or the distance to the core network path is below a threshold.

In 431 the eNB that now connects the UE to the network receives from the UE a measurement report similar to that 402 described above. In 432 it is determined whether a handover should be made similarly to the procedure in 404. In this example the eNB 484 decides that a handover is needed and initiates a handover of the UE to an eNB 486. In an embodiment, in 433, a new security key is generated in the eNB 484 for the target eNB 486, similarly to step 407 above and as described in 208. Accordingly, the security key to be used between the eNB 486 and the UE is generated from the security key used between the eNB 484 and the UE. Thereby, the security keys generated in 407 and 433 are derivable horizontally from the security key used between the eNB 482 and the UE. Thus, the security key used in the eNB 482 is a base key in a chain of security keys, said security keys being derivable from the base key.

In an embodiment, the new security keys may be transmitted to the target eNB 486 within the handover request 434 following the handover decision.

In steps 434 to 454 the UE switches its connection from the source eNB, eNB 484, to the target eNB, eNB 486. Steps 434 to 440 correspond to steps 406 to 412 explained above. In an embodiment, the source eNB 484 may update in 447 the path switch counter as explained in 208 after the target eNB has indicated acceptance of the UE to the source eNB. The target eNB may indicate its acceptance in response to performing admission control.

In an embodiment, the updated path switch counter may be transmitted to the target eNB after the admission control has been performed. This take place in response to the source eNB receiving a handover acknowledgement in 438 from the target eNB and/or after the handover command has been sent to the UE in 440.

The second phase ends.

In the third phase 442, the core network path of the UE may be provided by relaying 444 data of the UE through the access network on connections between the access nodes.

In 444 the source eNB relays UE data received from the eNB providing the core network path to the target eNB. Accordingly, UE data may now be relayed between the core network path provided by the eNB 482, the source eNB 482 and the target eNB.

In 456 the UE has established a connection to the target eNB and UE data may be relayed between the UE and the core network path through the eNBs between the UE and the core network path. This is similar to what has been described in 428 and 316. The number of eNBs through which the data d with the connection of the UE may be relayed is not limited.

In an embodiment an MME 492 originates a signalling message 457, e.g. a paging message, or a bearer management message such as bearer establishment or bearer release, to the UE. The signalling message is received at the eNB 482 providing the core network path of the UE.

In an embodiment the received signalling message may be relayed from the eNB 482 via eNB 484 to the eNB 486 providing access to the UE as illustrated by messages 458b between eNBs. This illustrates the embodiment described in connection with step 222.

In an embodiment, when the signalling message 457 is received at the eNB 482 providing the core network path, the eNB may determine whether a core network path switch of the UE should be performed in 458.

In an embodiment, determining whether a path switch should be made in 458 may be performed as described in step 221 of FIG. 2, for example. Accordingly, the reception of the signalling message 457 may exceed or meet the threshold for the patch switch, when e.g. a threshold for the path switch has been set to a single signalling message.

In an embodiment, when in 458 it is determined that a path switch should be made, the path switch may be triggered by the eNB transmitting a message 458b to the eNB serving the UE, which causes the path switch to be performed. Accordingly, the message may comprise a triggering message 458b. In an embodiment the triggering message may be relayed from the eNB 482 via eNB 484 to the eNB 486 providing access to the UE as illustrated by messages 458b between eNBs. In an embodiment, when in 458 it is determined that a path switch should be made, the path switch may be triggered by the eNB transmitting a message 458a comprising a triggering message 458b on the connection to the eNB 484 and to be relayed to the eNB serving the UE.

In an embodiment, the eNB 482 may transmit the MME a response message 458a comprising information associated with a procedure associated with the received signalling message. The information may indicate a rejection or interruption of the procedure, for example. In one example such information may indicate a failed delivery of the signalling message. The response message may comprise for example a NAS non-delivery message indicating that a NAS signalling message 457 can not be delivered to the UE. The response message may further comprise an identification of the cause for the rejection of the procedure and/or the non-delivery of the signalling message. For example, the identification of the cause may comprise an indication that a handover of the UE to another eNB has been initiated, e.g. “X2 HO triggered” cause. The response message may be transmitted after determining in 458 that a path switch should be made.

In an embodiment, the eNB 486 may determine that a core network path switch should be made in 459 on the basis of one or more messages received on the connection between eNBs. The received messages may comprise a triggering message or a signalling message to the UE as explained above. Accordingly, the determining whether a path switch should be initiated in 459 may comprise determining whether the message comprises a triggering message or a signalling message to the UE. When the eNB determines that the received message comprises a triggering message, in 459 it may decide to initiate the path.

When in 459 it is determined that the received message comprises a signalling message to the UE, the determining whether a path switch should be performed may be performed as described in 321, for example. Accordingly, in 459 it may be determined whether a threshold for the path switch has been met as described for example in 429.

As described above, the core network path switch may be initiated by at least two types of messages received at the eNB 486, the messages comprising a triggering message or a signalling message to the UE. Accordingly, it should be appreciated that in embodiments a threshold for the path switch may be set according to the type and number of messages received. For example, in embodiments the threshold may be set to a single triggering message.

In an embodiment in 459 the determining that a core network path switch should be performed comprises determining whether a signalling message associated with the connection of the UE has been received. The switching of the core network path may be performed as described as described in steps 222 and/or 322.

Following the step 459, the core network path switch may be performed as described in 322 for example. In 459 As explained above, the decision on the need for the core network patch switch may be performed in the eNB providing the core network path or the eNB providing access to the UE.

In 460 a path switch request may be transmitted to MME 492 after determining that a core network path switch should be performed. The path switch request may provide information to the MME that the UE has changed eNB. The path switch may comprise an identifier identifying the new eNB that now provides access to the UE. The third phase ends. In an embodiment after the path switch request has been transmitted, the path switch counter may be updated. Since the path switch was requested in 460 the core network path of the connection of the UE will be switched to the eNB 486 directly connecting to the UE and the counter may be initialized in 461. In this way the counter correctly indicates a distance of the connection of the UE that is relayed between eNBs. Thus, distance information may be kept updated even if the core network path is updated.

In the fourth phase 462 a core network path of the UE may be provided by the eNB providing access to the UE.

In 463, the MME generates one or more security keys for securing the connection between the UE and the eNB. The key may be generated using vertical key generation as is conventional in the E-UTRAN. More specifically, the MME may increase its locally kept Next hop Chaining Counter (NCC) value by one and compute a new fresh Next Hop (NH) by using a K_{ASME} and its locally kept NH value as input to a key generation function, of which an example is defined in Annex A.4 in 3GPP TS 33.401 referred to above. The MME should then send the newly computed {NH, NCC} pair to the target eNB in a path switch acknowledgement message. The target eNB may store the received {NH, NCC} pair for further handovers. Other existing unused stored {NH, NCC} pairs if any may be removed at the target eNB.

Accordingly, when the horizontal security key derivation is applied in the above embodiments, no resources are required from the MME to calculate security keys until a core network path switch. When the core network path switch is performed the security key derivation and delivery to the eNB may be performed as described above in connection with 463. The new security keys provided by the MME may be used in the target cell or target eNB of the following handover. The next handover may include e.g. intra-eNB handover between source and target cells of a single eNB, or an inter-eNB handover between source and target eNBs.

In 464 the MME responds to the path switch request with a path switch acknowledgement that indicates that the core network path of the UE has been switched. Both the access network connection and the core network path are now provided to the UE by a single eNB and the handover may be considered now completed.

It should be appreciated that when the core network path of the UE is switched to the eNB 486 at the MME, the MME may transmit signalling messages to the eNB 486 that now provides both the access and the core network path for the UE. The eNB 486 may deliver the received signalling messages to the UE. This is illustrated by the NAS message 465 that is transmitted to the UE via the eNB 486.

It should be further appreciated that when the core network path of the UE is switched to the eNB 486 at the MME, the MME may continue and/or retry a procedure that has been rejected prior to the path switch, with the eNB 486 providing access to the UE. Accordingly, the signalling message 465 may include the retransmission of the NAS signalling message 457 that was not successfully delivered at an earlier attempt.

In 466 the eNB transmits a release resource message towards the eNB that previously provided the core network path.

In 468 the eNB releases resources associated with the relaying of the core network path between eNBs.

In 466 and 470 the release resource message is propagated through the eNBs involved in relaying the core network path of the UE and finally to the eNB that previously provided the core network path to the UE. The resources associated with the relaying of the core network path between eNBs may be released in the eNBs in 472 and 474.

A block diagram in FIG. 5 shows a reference hardware configuration of an apparatus 500 according to an exemplary embodiment. The apparatus may be used for communications for example in the communications system of FIG. 1. The apparatus may be for example the eNB 152, 154 or 156 in FIG. 1. The apparatus 500 in FIG. 5 may comprise a transceiver unit 502 for radio communications. The transceiver may comprise a transmitter 506 and a receiver 504 that may be electrically interconnected with a processing unit 508. The transmitter 506 may receive a bit stream from the processing unit 508, and convert it to a radio frequency signal for transmission by the antenna 514. Correspondingly, the radio frequency signals received by the antenna 512 may be led to the receiver 504, which may convert the radio frequency signal into a bitstream that may be forwarded to the processing unit 508 for further processing.

The processing unit 508 is a central element that essentially comprises an arithmetic logic unit, a number of special registers and control circuits. For example, the functions implemented by the processing unit 508 in reception of transmissions typically comprise: channel estimation, equalisation, detection, decoding, reordering, de-interleaving, de-scrambling, channel de-multiplexing, and burst de-formatting. Memory unit 510, data medium where computer-readable data or programs, or user data can be stored, is connected to the processing unit 508. The memory unit 510 may typically comprise memory units that allow for both reading and writing (RAM) and memory whose contents can only be read (ROM).

The processing unit 508, the memory unit 510, and the transceiver unit 502 may be electrically interconnected to provide means for performing systematic execution of operations on the received and/or stored data according to the predefined, essentially programmed processes of the apparatus. In solutions according to an exemplary embodiment, the operations comprise functions for initiating a handover of a connection of user equipment, the connection comprising a path from an access network to a core network and switching the path to the core network on the basis of data received on the connection exceeding a threshold. These operations are described in more detail in connection with FIGS. 2, 3, 4a and 4b.

It should be noted that only elements necessary for describing an exemplary embodiment are illustrated in FIG. 5. For a person skilled in the art it is clear that an apparatus for receiving a transmission on a communications channel may comprise a plurality of further elements and functionalities not explicitly illustrated herein. In addition, the blocks illustrate logical or functional units that may be implemented in or with one or more physical units, irrespective of whether they are illustrated as one or more blocks in FIG. 5.

The steps/points, transmissions and related functions described above in FIGS. 2, 3, 4a and 4b are in no absolute chronological order, and some of the steps/points may be performed simultaneously or in an order differing from the given one. Other functions can also be executed between the steps/points or within the steps/points and other transmissions sent between the illustrated transmissions. Some of the steps/points or part of the steps/points can also be left out or replaced by a corresponding step/point or part of the step/point. In addition, the transmissions may also contain other information.

The storage circuitry 510 in FIG. 5 may be configured to store programming such as executable code or instructions (e.g., software or firmware), electronic data, databases, or other digital information, and may include processor-usable media. Processor-usable media may be embodied in any computer program product or article of manufacture which can contain, store, or maintain programming, data or digital information for use by or in connection with an instruction execution system including processing circuitry 508 in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random-access memory, read only memory, flash memory, cache memory, or other configurations capable of storing programming, data, or other digital information.

At least some embodiments or aspects described herein may be implemented using programming stored within appropriate storage circuitry 510 described above or communicated via a network or other transmission media and configured to control appropriate processing circuitry 508. For example, programming may be provided via appropriate media including, for example, embodied within articles of manufacture, embodied within a data signal (e.g., modulated carrier wave, data packets, digital representations, etc.) communicated via an appropriate transmission medium, such as a communication network (e.g., the Internet or a private network), wired electrical connection, optical connection or electromagnetic energy, for example, via communications interface 512, 514, or provided using other appropriate communication structure or medium. Exemplary programming including processor-usable code may be communicated as a data signal embodied in a carrier wave in but one example. It should be appreciated that the embodiments described above may be applied for various kinds of handovers including a handover between cells of the eNB i.e. an intra-eNB handover, and an inter-system handover, e.g. a handover between GSM and E-UTRAN.

It should be appreciated that the embodiments described above may also be applied independently from handovers. Accordingly, the step of determining whether a core network path switch should be performed may also be performed in situations other that handovers. Thus, data associated with a connection of the UE, the data comprising e.g. a signalling message, keep alive message and/user data, may initiate the switching of the core network path.

It should be appreciated that the switch of a core network path may be performed at any later time following a handover of UE from a source access node to a target access node, when a condition or conditions for initiating the core network path switch is met.

When a security key to be used between a target eNB and the UE is generated using horizontal key derivation the level of security provided in a network may be decreased than if vertical key generation was used. Therefore, it should be appreciated that in the above embodiments one or more conditions for the core network path switch may be set on the basis of one or more security aspects. The security aspects may comprise ensuring a level of security in the connection of the UE. The level of security may be used for determining the conditions for the core network path switch, e.g. one or more of the thresholds in steps 218, 220, 318 and 320. For example, when the level of security is set high the threshold for data in 218 may be set as one user plane data packet, and the first user plane data packet to/from the UE may initiate a core network path switch. Since a new security key to the target eNB may be generated in the MME in the path switch process as described in 463, the lowered security caused by horizontal key derivation may be limited to the first packet. In another example where the level of security is set high a threshold for distance, e.g a counter indicating a distance may be set to ‘2’ as in the above example. Thus, the core network path may be maintained when the UE is handed over to a target access node the first time and a second handover of the UE may cause a core network path switch. Since the core network path is maintained only in the first handover between access nodes, the number of access nodes using keys of the same chain may kept small.

In embodiments using horizontal key derivation, a lower security level may be provided by setting the threshold for data for more than one packet and/or the threshold for distance to allow the core network path to be maintained for more than one handover between access nodes, e.g. a counter value of ‘3’ or greater in the above example.

It will be obvious to a person skilled in the art that as technology advances, the inventive concept can be implemented in various ways. The invention and its embodiments are not limited to the examples described above but may vary within the scope of the claims.

1. A method comprising:
initiating a handover of a connection of user equipment, the connection comprising a path from an access network to a core network; and
switching the path to the core network on the basis of data received on the connection exceeding a threshold.

2. A method according to claim 1, comprising:
executing a handover of the user equipment from a source access node to a target access node, wherein the source access node provides the path from the access network to the core network; and
relaying data between the source access node and the target node when data received on the connection is below a threshold.

3. A method according to claim 1, comprising:
relaying data between the user equipment and an access node providing the path from the access network to the core network; and
establishing a new path to the core network, on the basis of the data received on the connection exceeding the threshold.

4. A method according to claim 1, comprising:
determining a distance between the user equipment and an access node providing the path from the access network to the core network; and
establishing a new path to the core network, on the basis of the distance exceeding a threshold.

5. A method according to claim 1, wherein the distance comprises one or more from a group comprising: an omitted path switch counter, a number of access nodes, correspondence of tracking area identifiers of access nodes, addresses of access nodes, measurement information on access nodes.

6. A method according to claim 1, comprising:
initiating a second handover of the user equipment from a source access node to a target access node;
executing the second handover; and
maintaining the path to the core network, on the basis of the data received on the network connection is below a threshold.

7. A method according to claim 1, wherein the handover comprises a handover of the user equipment from a source access node to a target access node, said source access node providing the path from the access network to the core network, the method comprising:
deriving a security key for the target access node from a security key used between the source access node and the user equipment; and
maintaining the path to the core network at the source access node.

8. A method according to claim 1, deriving the security key to a plurality of target access nodes from a security key of a first source access node of a plurality of handovers of the user equipment, each of said handovers comprising a source and a target access node.

9. A method according to claim 1, comprising:
setting the threshold on the basis of deriving a security key of a target access node from a security key of a first source access node of a plurality of handovers of the user equipment, each of said handovers comprising a source and a target access node.

10. (canceled)

11. A method according to claim 1, wherein deriving a security key for a target access node comprises horizontal key derivation.

12.-24. (canceled)

25. An apparatus configured to:
initiate a handover of a connection connecting user equipment, the connection comprising a path from an access network to a core network; and
switch the path to the core network on the basis of data received on the connection exceeding a threshold.

26. An apparatus according to claim 25, configured to:
execute a handover of the user equipment from a source access node to a target access node, wherein the source access node provides the path from the access network to the core network; and
relay data between the source access node and the target node, when data received on the connection is below a threshold.

27. An apparatus according to claim 25, configured to: relay data between the user equipment and an access node providing the path from the access network to the core network; and
establish a new path to the core network, on the basis of the data received on the connection exceeding the threshold.

28. An apparatus according to claim 25, configured to:
determine a distance between the user equipment and an access node providing the path from the access network to the core network; and
establish a new path to the core network, on the basis of the distance exceeding a threshold.

29. An apparatus according to claim 25, wherein the distance comprises one or more from a group comprising: an omitted path switch counter, a number of access nodes, correspondence of tracking area identifiers of access nodes, addresses of access nodes, measurement information on access nodes.

30. An apparatus according to claim 25, configured to:
initiate a second handover;
execute the second handover of the user equipment from a second source access node to a second target access node; and
maintain the path to the core network, on the basis of the data received on the network connection is below a threshold.

31. An apparatus according to claim 25, wherein the handover comprises a handover of the user equipment from a source access node to a target access node, said source access node providing the path from the access network to the core network, the apparatus being configured to:
derive a security key for the target access node from a security key used between the source access node and the user equipment; and
maintain the path to the core network at the source access node.

32. An apparatus according to claim 25, configured to derive the security key to a plurality of target access nodes from a security key of a first source access node of a plurality of handovers of the user equipment, each of said handovers comprising a source and a target access node.

33. An apparatus according to claim 25, configured to:
set the threshold on the basis of deriving a security key of a target access node from a security key of a first source access node of a plurality of handovers of the user equipment, each of said handovers comprising a source and a target access node.

34. (canceled)

35. An apparatus according to claim 25, wherein deriving a security key for a target access node comprises horizontal key derivation.

36.-54. (canceled)

55. An article of manufacture comprising a computer readable medium and embodying program instructions thereon executable by a computer operably coupled to a memory, which, when executed by the computer, carry out: initiating a handover of a connection of user equipment, the connection comprising a path from an access network to a core network; and switching the path to the core network on the basis of data received on the connection exceeding a threshold.

56. (canceled)

57. (canceled)
